(19) United States
(12) Patent Application Publication
(10) Pub. No.: US 2026/0153736 A1
(43) Pub. Date: Jun. 4, 2026

(54) VEHICLE DISPLAY DEVICE

(71) Applicant: YAZAKI CORPORATION, Tokyo (JP)

(72) Inventors: Hiroshi Sano, Makinohara-shi (JP); Yuta Miyake, Makinohara-shi (JP); Takayuki Mizushima, Shimada-shi (JP)

(21) Appl. No.: 19/402,704

(22) Filed: Nov. 26, 2025

(30) Foreign Application Priority Data
Nov. 29, 2024 (JP) 2024-209004

(51) Int. Cl. G02B 27/01; G02B 27/09

(52) U.S. Cl. CPC G02B 27/0149; G02B 27/0101; G02B 27/0955; G02B 27/0977; G02B 2027/0161

(57) ABSTRACT

A vehicle display device includes a light-transmissive display, a backlight unit projecting light onto a rear surface of the display and emitting display information as display light from a front surface of the display, at least one reflective member reflecting the display light emitted from the display and projecting the display light onto a projected part, and an outer case accommodating these. The backlight unit includes a Fresnel lens and a microlens, and the Fresnel lens and the microlens are placed with an emission surface and an incidence surface facing each other.

### CROSS-REFERENCE TO RELATED APPLICATION(S)

The present application claims priority to and incorporates by reference the entire contents of Japanese Patent Application No. 2024-209004 filed in Japan on Nov. 29, 2024.

### BACKGROUND OF THE INVENTION

### 1. Field of the Invention

The present invention relates to a vehicle display device.

### 2. Description of the Related Art

A vehicle is conventionally equipped with a vehicle display device displaying a virtual image of information provided to an occupant inside a cabin. This vehicle display device is a so-called head-up display device, and includes a light-transmissive display that displays display information to be projected onto a projected part, a backlight unit that projects light onto a rear surface of the display and emits display information as display light from a front surface of the display, a reflective member that reflects the display light emitted from the display and projects the display light onto the projected part, and an outer case that accommodates these. This vehicle display device projects the display light reflected off the reflective member onto the projected part outside the outer case and allows the occupant to visually recognize the display information in accordance with the projected display light as a virtual image. A vehicle display device of this type is disclosed, for example, in Japanese Patent Application Laid-open No. JP 2019-078 966 A.

Now, in the vehicle display device, the backlight unit includes a lens member for distributing outgoing light from a light source to the entire rear surface of the display to display a high-luminance virtual image. For example, in a conventional backlight unit, by use of a lens member having an increased thickness or the like, incident light is bent to distribute outgoing light from the lens member over a wide area. Unfortunately, such a conventional vehicle display device may cause upsizing of the backlight unit at least in the thickness direction of the lens member.

### SUMMARY OF THE INVENTION

An object of the present invention is to provide a vehicle display device displaying a high-luminance virtual image while suppressing upsizing of a backlight unit.

In order to achieve the above mentioned object, a vehicle display device according to one aspect of the present invention includes a display having light transmissiveness and configured to display display information to be visually recognized as a virtual image by an occupant inside a cabin; a backlight unit configured to project light onto a rear surface of the display and to emit the display information as display light from a front surface of the display; at least one reflective member configured to reflect the display light emitted from the display and to project the display light onto a projected part; and an outer case that accommodates the display, the backlight unit, and the reflective member, wherein the backlight unit includes a light source, a Fresnel lens, and a microlens, the Fresnel lens being configured to allow outgoing light from the light source to be incident on an incidence surface and to be emitted from an emission surface as parallel light orthogonal to the emission surface, the microlens being configured to allow the parallel light to be incident on an incidence surface and to be emitted from an emission surface toward the rear surface of the display as diffused light, and the Fresnel lens and the microlens are placed with the emission surface of the Fresnel lens and the incidence surface of the microlens facing each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view illustrating a vehicle display device according to an embodiment;

FIG. 2 is a perspective view illustrating a backlight unit according to the embodiment;

FIG. 3 is a perspective sectional view describing a main portion of an internal configuration of the backlight unit according to the embodiment;

FIG. 4 is an exploded perspective view describing a main portion of the internal configuration of the backlight unit according to the embodiment;

FIG. 5 is an exploded perspective view describing a Fresnel lens and a microlens; and

FIG. 6 is an explanatory diagram describing an optical path of the backlight unit.

### DETAILED DESCRIPTION OF THE PREFERRED EMBODIMENTS

An embodiment of a vehicle display device according to the present invention will be described in detail below with reference to the drawings. Note that this embodiment should not be construed to limit this invention.

### Embodiment

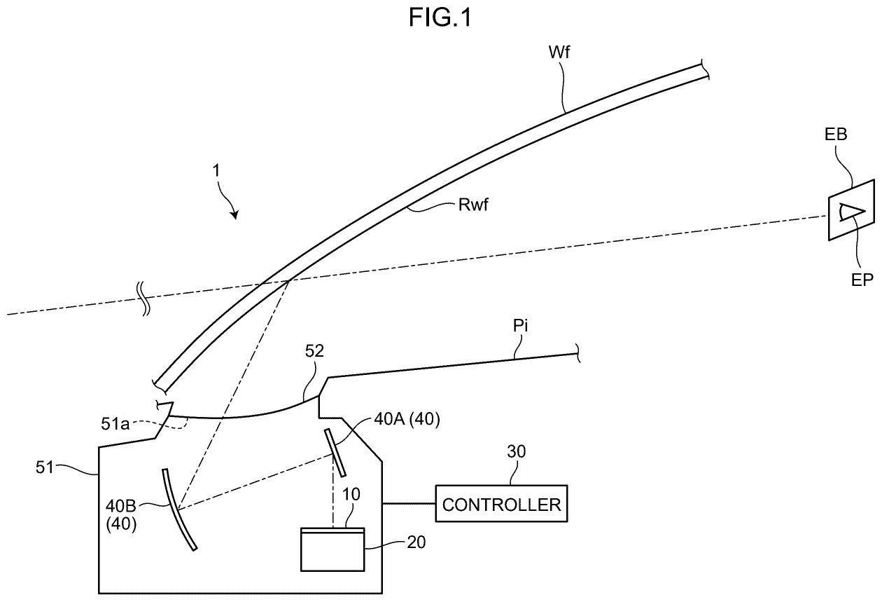

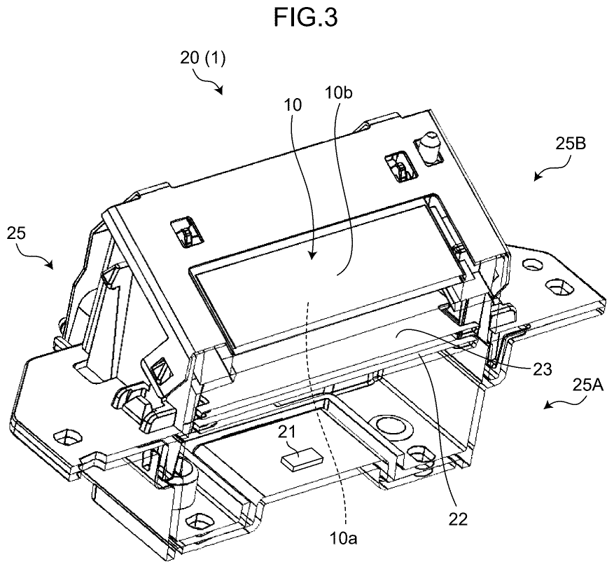

One embodiment of the vehicle display device according to the present invention will be described with reference to FIGS. 1 to 6.

The reference sign 1 in FIGS. 1 to 4 denotes the vehicle display device of this embodiment. This vehicle display device 1 is a so-called head-up display device displaying a virtual image of information provided to an occupant inside a cabin of a vehicle (such as an automobile).

The vehicle display device 1 includes a light-transmissive, plate-shaped display 10 that displays display information to be visually recognized as a virtual image by the occupant inside the cabin, and a backlight unit 20 that projects light onto a rear surface 10a of the display 10 and emits the display information as display light from a front surface 10b of the display 10 (FIGS. 1 to 4). The vehicle display device 1 includes a controller 30 controlling the display 10 and the backlight unit 20 (FIG. 1).

The vehicle display device 1 further includes at least one reflective member 40 reflecting the display light emitted from the display 10 and projecting this display light onto a projected part Rwf (FIG. 1). The vehicle display device 1 reflects the display light off the projected part Rwf toward an eye point EP or an eye box EB of the occupant. The eye point EP indicates a position of an eye of the occupant inside the cabin. The eye box EB indicates a range of the eye point EP where the virtual image is visually recognizable.

Herein, the projected part Rwf indicates a windshield (herein, a front windshield Wf) itself or a portion thereof. Alternatively, the projected part Rwf may be formed as a half mirror that receives the display light from the reflective member 40 on a reflective surface and reflects the display light toward the eye point EP or the eye box EB of the occupant and that allows light from outside the vehicle to be emitted toward the occupant. For example, the projected part Rwf as the half mirror is formed like a semi-transmissive film along the curved shape of the windshield (front windshield Wf) and is adhered to a wall surface of this windshield on an interior side of the cabin with an adhesive. Alternatively, the projected part Rwf as the half mirror may be formed like a semi-transmissive film along the curved shape of the windshield (front windshield Wf) and be sealed in the laminated glass windshield together with an interlayer. Alternatively, the projected part Rwf as the half mirror may be a semi-transmissive coating coated on the wall surface of the windshield (front windshield Wf) on the interior side of the cabin through application or the like. Note that the projected part Rwf may be a combiner covering the front windshield Wf from the interior side of the cabin.

The vehicle display device 1 includes an outer case 51 accommodating the display 10, the backlight unit 20, and the reflective member 40, and a transparent cover 52 closing an opening 51a of this outer case 51 (FIG. 1). The vehicle display device 1 described herein is accommodated inside an instrument panel Pi in the cabin with the cover 52 exposed.

As the display 10, for example, a light-transmissive thin film transistor liquid crystal display (TFT liquid crystal display) or the like is used. The display 10, for example, displays image information of characters, numbers, figures, and the like as the display information. The controller 30 controls this display 10 to control display of the display information.

As the reflective member 40, a first reflective member 40A reflecting the display light emitted from the display 10 and a second reflective member 40B reflecting reflected light reflected off the first reflective member 40A are provided (FIG. 1). As the first reflective member 40A, for example, a plane mirror or a concave mirror is used. In this example, a plane mirror is used as the first reflective member 40A. As the second reflective member 40B, for example, a concave mirror is used. In the vehicle display device 1, the display light emitted from the display 10 is reflected off the first reflective member 40A toward the second reflective member 40B and is magnified at and reflected off the second reflective member 40B. The second reflective member 40B emits the magnified and reflected display light through the cover 52 to the outside of the outer case 51 and projects the display light onto the projected part Rwf present beyond the outer case 51 (FIG. 1).

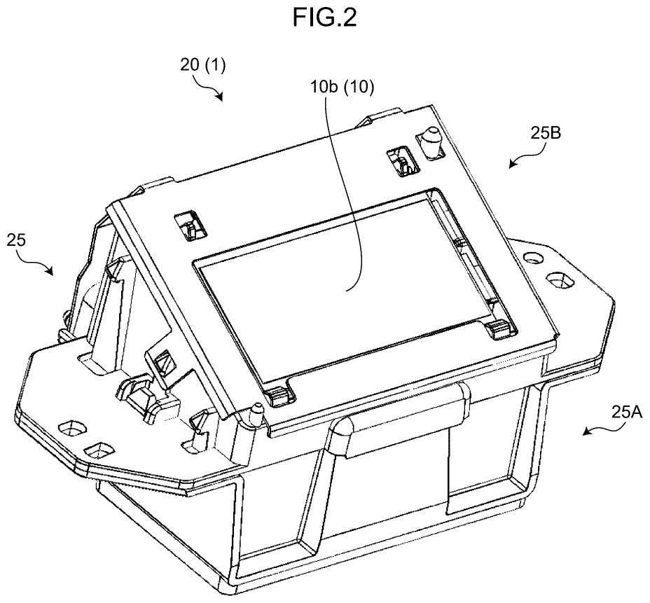

The backlight unit 20 includes a light source 21, a Fresnel lens 22 that allows outgoing light from the light source 21 to be incident on an incidence surface 22a and to be emitted from an emission surface 22b as parallel light orthogonal to the emission surface 22b, and a microlens 23 that allows the parallel light to be incident on an incidence surface 23a and to be emitted from an emission surface 23b toward the rear surface 10a of the display 10 as diffused light (FIGS. 2 to 6). For example, the light source 21 described herein is a light-emitting element and uses a light-emitting diode element. The backlight unit 20 includes an inner case 25 accommodating the light source 21, the Fresnel lens 22, and the microlens 23 and holding the display 10 (FIGS. 2 to 4).

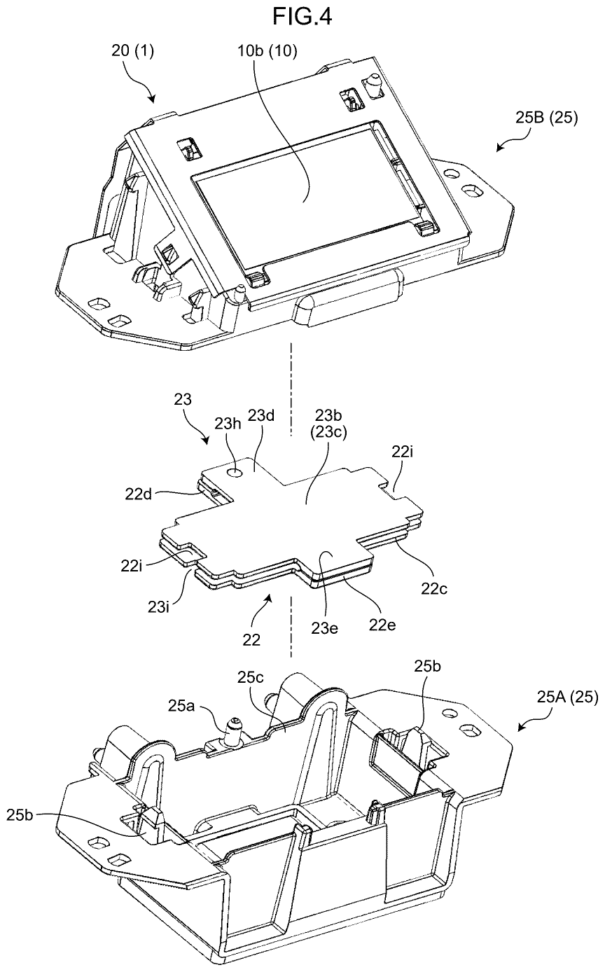

The Fresnel lens 22 includes a Fresnel lens body 22c provided with the incidence surface 22a and the emission surface 22b (FIGS. 4 to 6). The Fresnel lens body 22c is, for example, formed to have a rectangular flat plate shape. In this Fresnel lens body 22c, the emission surface 22b is formed to have a saw-tooth shape that allows the parallel light orthogonal to the emission surface 22b to be emitted.

The microlens 23 includes a microlens body 23c provided with the incidence surface 23a and the emission surface 23b (FIGS. 4 to 6). The microlens body 23c is, for example, formed to have a rectangular flat plate shape. In this microlens body 23c, a plurality of convex portions allowing incident light to be diffused and emitted are disposed on the emission surface 23b.

The Fresnel lens 22 and the microlens 23 are placed with the emission surface 22b of the Fresnel lens 22 and the incidence surface 23a of the microlens 23 facing each other. Without using a conventional thick lens member, the backlight unit 20 can distribute the outgoing light from the light source 21 toward the rear surface 10a of the display 10 over a wide area by placing the thin Fresnel lens 22 and the thin microlens 23 in an overlapping manner at an interval narrower than the thickness of the conventional lens member.

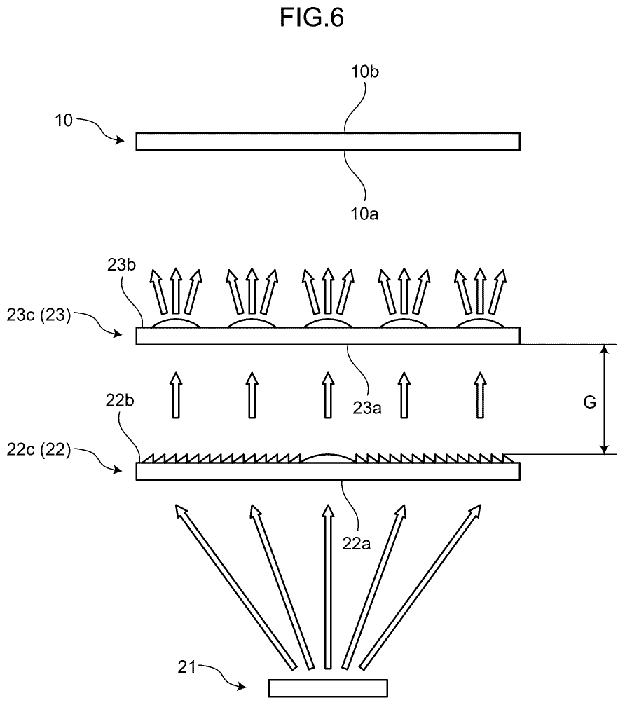

In this backlight unit 20, a gap G is provided between the emission surface 22b of the Fresnel lens 22 and the incidence surface 23a of the microlens 23 (FIG. 6). This can prevent deformation or the like of the saw-tooth shape of the emission surface 22b of the Fresnel lens 22 and can protect the emission surface 22b in the backlight unit 20. The backlight unit 20 is configured as below to maintain the gap G.

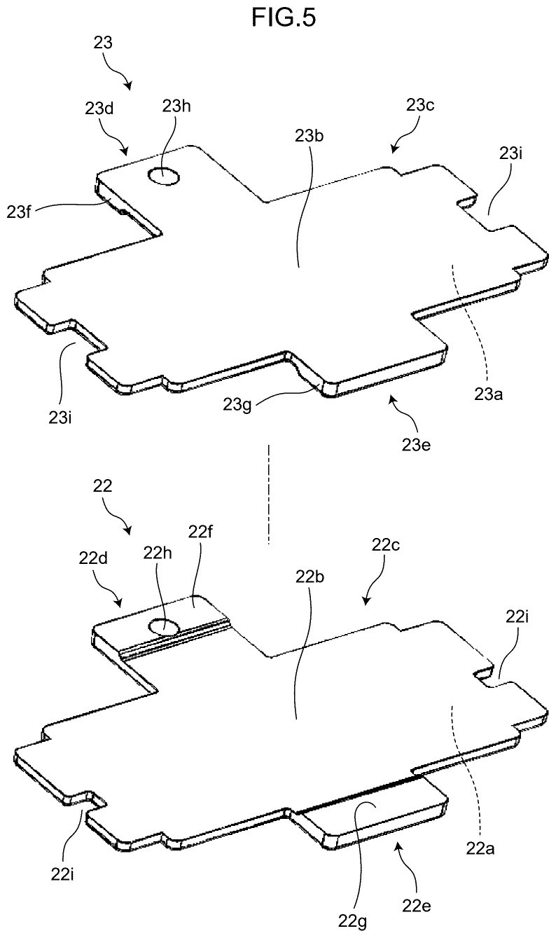

The Fresnel lens 22 includes a first support 22d protruding from the Fresnel lens body 22c on the same plane as the incidence surface 22a and the emission surface 22b of the Fresnel lens body 22c, and a second support 22e protruding from the Fresnel lens body 22c on the same plane as the incidence surface 22a and the emission surface 22b of the Fresnel lens body 22c (FIGS. 4 and 5). The microlens 23 includes a first facing portion 23d protruding from the microlens body 23c on the same plane as the incidence surface 23a and the emission surface 23b of the microlens body 23c and placed against the first support 22d, and a second facing portion 23e protruding from the microlens body 23c on the same plane as the incidence surface 23a and the emission surface 23b of the microlens body 23c and placed against the second support 22e (FIGS. 4 and 5).

The first support 22d and the second support 22e described herein are each formed to have a rectangular flat plate shape. The first support 22d and the second support 22e each protrude in opposite directions relative to the Fresnel lens body 22c. The first facing portion 23d and the second facing portion 23e described herein are each formed to have a rectangular flat plate shape. The first facing portion 23d and the second facing portion 23e each protrude in opposite directions relative to the microlens body 23c.

Furthermore, the first support 22d is provided with a first mount 22f protruding from a wall surface on the emission surface 22b side of the Fresnel lens body 22c toward the first facing portion 23d (FIG. 5). The second support 22e is provided with a second mount 22g protruding from a wall surface on the emission surface 22b side of the Fresnel lens body 22c toward the second facing portion 23e (FIG. 5). The first facing portion 23d is provided with a first installed portion 23f protruding from a wall surface on the incidence surface 23a side of the microlens body 23c toward the first mount 22f and placed on the first mount 22f (FIG. 5). The second facing portion 23e is provided with a second installed portion 23g protruding from a wall surface on the incidence surface 23a side of the microlens body 23c toward the second mount 22g and placed on the second mount 22g (FIG. 5).

The first mount 22f and the second mount 22g described herein are each formed to have a rectangular flat plate shape. The first mount 22f and the second mount 22g are each placed at a tip in its protruding direction. The first installed portion 23f and the second installed portion 23g described herein are each formed to have a rectangular flat plate shape. The first installed portion 23f and the second installed portion 23g are each placed at a tip in its protruding direction.

By placing the first installed portion 23f on the first mount 22f and placing the second installed portion 23g on the second mount 22g, the Fresnel lens 22 and the microlens 23 are provided with the gap G between the emission surface 22b of the Fresnel lens body 22c and the incidence surface 23a of the microlens body 23c. In this way, in this backlight unit 20, the first mount 22f and the first installed portion 23f and the second mount 22g and the second installed portion 23g are disposed separately on the Fresnel lens 22 and the microlens 23, which can contribute to reduction in the thickness of the Fresnel lens 22 and the microlens 23 in comparison with a case where these are disposed only on one of the Fresnel lens 22 and the microlens 23.

The Fresnel lens 22 and the microlens 23 use a positioning pin 25a disposed on the inner case 25 to maintain their mutual positional relationship (FIG. 4). The first support 22d is thus provided with a through hole 22h into which the positioning pin 25a is inserted to perform positioning of the Fresnel lens 22 relative to the inner case 25 (FIG. 5). The first facing portion 23d is provided with a through hole 23h into which the positioning pin 25a is inserted to perform positioning of the microlens 23 relative to the Fresnel lens 22 (FIGS. 4 and 5). Herein, the through hole 22h penetrates the first mount 22f and the through hole 23h penetrates the first installed portion 23f to regulate mutual positions between the first mount 22f and the first installed portion 23f, which maintains the above-described gap G.

Furthermore, the Fresnel lens 22 and the microlens 23 use a pair of positioning protrusions 25b, in addition to the positioning pin 25a, disposed on the inner case 25 to maintain their mutual positional relationship (FIG. 4). The Fresnel lens body 22c is thus provided with a cut-away portion 22i for each positioning protrusion 25b to insert the positioning protrusion 25b (FIGS. 4 and 5). The microlens body 23c is provided with a cut-away portion 23i for each positioning protrusion 25b to insert the positioning protrusion 25b (FIGS. 4 and 5).

To be specific, the inner case 25 described herein includes a housing member 25A and a cover member 25B (FIGS. 2 to 4). In the housing member 25A, the light source 21 is accommodated inside, and the Fresnel lens 22 and the microlens 23 are installed in an opening 25c (FIG. 4). The positioning pin 25a and the pair of positioning protrusions 25b are disposed on the periphery of the opening 25c (FIG. 4). The cover member 25B covers the Fresnel lens 22 and the microlens 23 together with the opening 25c of the housing member 25A in a position where assembly to the housing member 25A is complete. The display 10 is held by the cover member 25B with the front surface 10b exposed.

As described above, the backlight unit 20 of this embodiment can distribute the outgoing light from the light source 21 toward the rear surface 10a of the display 10 over a wide area without using a conventional thick lens member. That is, without using a conventional thick lens member, the backlight unit 20 of this embodiment can place the Fresnel lens 22 and the microlens 23 in an overlapping manner at an interval narrower than the thickness of the conventional lens member, which can yield a high light distribution function while suppressing upsizing of the structure of the lens configuration. Thus, the vehicle display device 1 of this embodiment can display a high-luminance virtual image while suppressing upsizing of the backlight unit 20.

Furthermore, the backlight unit 20 of this embodiment does not need to adjust the light distribution area by changing the thickness of the lens member as in a conventional manner and can adjust the light distribution area only by changing the saw-tooth shape of the Fresnel lens 22. Thus, the vehicle display device 1 of this embodiment has excellent flexibility in designing the backlight unit 20 when the light distribution area is adjusted and can flexibly cope with upsizing of the display 10.

The backlight unit of the vehicle display device according to the present embodiment can distribute the outgoing light from the light source toward the rear surface of the display over a wide area by placing the Fresnel lens and the microlens in an overlapping manner, without using a conventional thick lens member. That is, without using a conventional thick lens member, this backlight unit can place the Fresnel lens and the microlens in an overlapping manner at an interval narrower than the thickness of the conventional lens member, which can yield a high light distribution function while suppressing upsizing of the structure of the lens configuration. Thus, the vehicle display device according to the present embodiment can display a high-luminance virtual image while suppressing upsizing of the backlight unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
a display having light transmissiveness and configured to display display information to be visually recognized as a virtual image by an occupant inside a cabin;
a backlight unit configured to project light onto a rear surface of the display and to emit the display information as display light from a front surface of the display;
at least one reflective member configured to reflect the display light emitted from the display and to project the display light onto a projected part; and
an outer case that accommodates the display, the backlight unit, and the reflective member, wherein
the backlight unit includes a light source, a Fresnel lens, and a microlens, the Fresnel lens being configured to allow outgoing light from the light source to be incident on an incidence surface and to be emitted from an emission surface as parallel light orthogonal to the emission surface, the microlens being configured to allow the parallel light to be incident on an incidence surface and to be emitted from an emission surface toward the rear surface of the display as diffused light, and
the Fresnel lens and the microlens are placed with the emission surface of the Fresnel lens and the incidence surface of the microlens facing each other.

2. The vehicle display device according to claim 1, wherein
a gap is provided between the emission surface of the Fresnel lens and the incidence surface of the microlens.

3. The vehicle display device according to claim 2, wherein
the Fresnel lens includes a Fresnel lens body, a first support, and a second support, the Fresnel lens body being provided with the incidence surface and the emission surface of the Fresnel lens, the first support protruding from the Fresnel lens body on a same plane as the incidence surface and the emission surface of the Fresnel lens body, the second support protruding from the Fresnel lens body on the same plane as the incidence surface and the emission surface of the Fresnel lens body,
the microlens includes a microlens body, a first facing portion, and a second facing portion, the microlens body being provided with the incidence surface and the emission surface of the microlens, the first facing portion protruding from the microlens body on a same plane as the incidence surface and the emission surface of the microlens body and being placed against the first support, the second facing portion protruding from the microlens body on the same plane as the incidence surface and the emission surface of the microlens body and being placed against the second support,
the first support is provided with a first mount protruding from a wall surface on a side of the emission surface of the Fresnel lens body toward the first facing portion,
the second support is provided with a second mount protruding from a wall surface on the side of the emission surface of the Fresnel lens body toward the second facing portion,
the first facing portion is provided with a first installed portion protruding from a wall surface on a side of the incidence surface of the microlens body toward the first mount, the first installed portion being placed on the first mount,
the second facing portion is provided with a second installed portion protruding from a wall surface on the side of the incidence surface of the microlens body toward the second mount, the second installed portion being placed on the second mount, and
by placing the first installed portion on the first mount and placing the second installed portion on the second mount, the Fresnel lens and the microlens are provided with the gap between the emission surface of the Fresnel lens body and the incidence surface of the microlens body.

4. The vehicle display device according to claim 3, wherein
the backlight unit includes an inner case accommodating the light source, the Fresnel lens, and the microlens and holding the display,
a positioning pin is disposed on the inner case,
the first support is provided with a through hole, the positioning pin being inserted into the through hole to perform positioning of the Fresnel lens relative to the inner case, and
the first facing portion is provided with a through hole, the positioning pin being inserted into the through hole to perform positioning of the microlens relative to the Fresnel lens.
